(19) United States
(12) Patent Application Publication
(10) Pub. No.: US 2019/0061748 A1
(43) Pub. Date: Feb. 28, 2019

(54) COLLISION PREDICTION APPARATUS

(71) Applicant: DENSO CORPORATION, Kariya-city, Aichi-pref. (JP)

(72) Inventor: Takahiro BABA, Kariya-city, Aichi-pref. (JP)

(21) Appl. No.: 16/079,333

(22) PCT Filed: Feb. 13, 2017
(86) PCT No.: PCT/JP2017/005186

§ 371 Date: Aug. 23, 2018

(30) Foreign Application Priority Data
Feb. 24, 2016 (JP) 2016-033531

(51) Int. Cl. B60W 30/095; G06K 9/00; B60W 30/09; B60W 50/14

(52) U.S. Cl. CPC B60W 30/0956; B60W 30/0953; G06K 9/00825; B60W 30/09; B60W 2050/143; B60W 2550/30; B60W 2520/06; B60W 2550/10; B60W 50/14

(57) ABSTRACT

A collision prediction apparatus including: an object detection section that detects an object present ahead of an own vehicle; and a collision prediction position calculation section that calculates a collision prediction position that is a position where the object is predicted to collide with the own vehicle in the future based on a position of the object detected by the object detection section relative to the own vehicle, wherein the collision prediction position calculation section corrects the collision prediction position when the object detected by the object detection section is traveling in an opposite direction to the own vehicle at a position deviated from a traveling direction of the own vehicle, and the own vehicle turns in a direction crossing a traveling direction of the object.

### CROSS-REFERENCE TO RELATED APPLICATIONS

The present application is based on Japanese Patent Application No. 2016-033531 filed Feb. 24, 2016, the description of which is incorporated herein by reference.

### TECHNICAL FIELD

The present disclosure relates to a collision prediction apparatus installed in a vehicle to predict a collision between an object present ahead of the vehicle and the vehicle.

### BACKGROUND ART

In recent years, along with the advancement of sensors and data processing, more vehicles are equipped with a driving support apparatus to avoid collision accidents caused by entry of an object into the path of the own vehicle from the lateral direction. Such a driving support apparatus needs to highly accurately identify an object that is likely to collide with the own vehicle.

Techniques for highly accurately identifying an object that is likely to collide with the own vehicle are disclosed, for example, in PTL 1. In the technique disclosed in PTL 1, a turning-round angle of the own vehicle is calculated by time integration of a yaw rate detected by a yaw rate sensor mounted to the own vehicle. Based on the calculated turning-round angle, the coordinate of the object present in the image captured by a camera is corrected. With this configuration, the influence of errors in a detected position of the object due to turning round of the own vehicle can be reduced, resulting in an accurate determination of the collision probability.

### CITATION LIST

### Patent Literature

[PTL 1] JP 2004-103018 A

### SUMMARY OF THE INVENTION

Coordinate information of the object present in the image is typically used not only for determination of the collision probability, but also for various processing. Therefore, when the coordinate of the object is not appropriately corrected, the influence of erroneous correction increases in the technique disclosed in PTL 1.

The present disclosure has been made to solve the aforementioned problems, and has a main object to provide a collision prediction apparatus that can improve the accuracy of collision prediction, while reducing the influence of a correction that is required due to turning (turning round) of the own vehicle in the prediction of a collision between the own vehicle and an object.

The present disclosure relates to a collision prediction apparatus including: an object detection section that detects an object present ahead of an own vehicle; and a collision prediction position calculation section that calculates a collision prediction position that is a position where the object is predicted to collide with the own vehicle in the future based on a position of the object detected by the object detection section relative to the own vehicle, wherein the collision prediction position calculation section corrects the collision prediction position when the object detected by the object detection section is traveling in an opposite direction to the own vehicle at a position deviated from a traveling direction of the own vehicle, and the own vehicle turns in a direction crossing a traveling direction of the object.

Based on the position of the object detected by the object detection section relative to the own vehicle, the collision prediction position that is a position where the object is predicted to collide with the own vehicle in the future is calculated by the collision prediction position calculation section. In this case, when the own vehicle turns in the direction crossing the traveling direction of the object, a position of the object in the information detected by the object detection section may be deviated from the actual position of the object due to turning of the own vehicle, which may lead to a positional error in the collision prediction, which occurs according to the above deviation. As a countermeasure against this problem, the collision prediction position is corrected when the object detected by the object detection section is traveling in an opposite direction to the own vehicle at the position deviated from the traveling direction of the own vehicle, and the own vehicle turns in the direction crossing the traveling direction of the object. Accordingly, even when the position of the object in the information deviates from the actual position of the object due to turning of the own vehicle, the influence of the above deviation can be reduced by correcting the collision prediction position, resulting in improvement of the accuracy of collision prediction. In addition, by performing a correction, which is for reducing the influence of the above deviation of the position of the object in the information, only to the collision prediction position, the influence of the erroneous correction, if any, can be minimized.

### BRIEF DESCRIPTION OF THE DRAWINGS

The object described above and other objects, characteristics, and advantageous effects of the present disclosure will be clarified by the detailed description below with reference to the accompanying drawings. In the accompanying drawings:

FIG. 1 is a schematic diagram showing the configuration of a driving support apparatus according to the present embodiment;

FIG. 2 is a diagram showing a method of approximating the relative position of an oncoming vehicle in a case where an own vehicle travels straight;

FIG. 3 is a diagram showing a method of approximating the relative position of the oncoming vehicle in a case where the own vehicle turns in the direction crossing the traveling direction of the oncoming vehicle;

FIG. 4 is a flowchart of control performed by a detection ECU according to the present embodiment.

### DESCRIPTION OF EMBODIMENTS

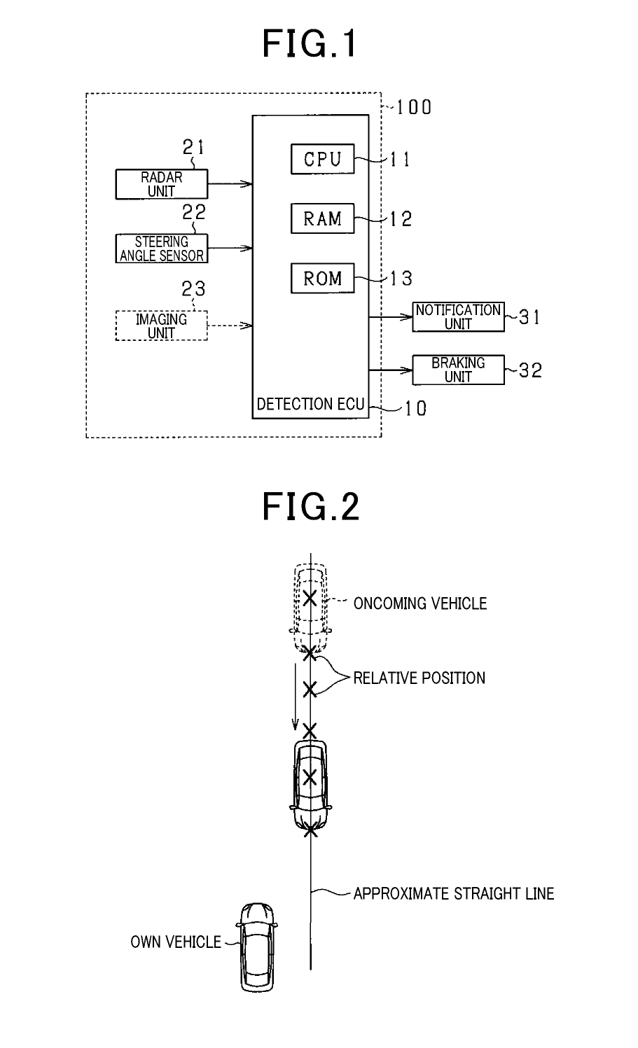

FIG. 1 illustrates a driving support apparatus 100 mounted to a vehicle (own vehicle) and detecting an object present in the surrounding area of the own vehicle such as ahead of the own vehicle in the traveling direction to perform driving support control. The driving support control functions as a PCS system (pre-crash safety system) for avoiding collisions with objects or for reducing collision damage. The driving support apparatus 100 also functions as a collision prediction apparatus according to the present embodiment.

The driving support apparatus 100 includes a detection ECU 10, a radar unit 21 and a steering angle sensor 22.

The radar unit 21 is a known millimeter wave radar, for example, that uses a high frequency signal in the millimeter waveband as transmission waves. The radar unit 21 is disposed at the front end part of the own vehicle, and defines a range within a predetermined detection angle as a detection range in which objects can be detected. In the detection range, the position of an object is detected. Specifically, search waves are transmitted at a predetermined cycle to receive reflected waves by using a plurality of antennas. Based on the transmission time of the search waves and the reception time of the reflected waves, the distance to the object is calculated. The radar unit 21 also calculates a relative speed of the object (specifically, a relative speed in the traveling direction of the vehicle) from the frequencies of the reflection waves from the object, which vary due to the Doppler Effect. In addition, the radar unit 21 calculates the azimuth of the object using the phase difference between the reflected waves received by the plurality of antennas. When the position and azimuth of the object are successfully calculated, the position of the object relative to the own vehicle can be specified. Hence, the radar unit 21 corresponds to an object detection section. The radar unit 21 transmits search waves, receives reflected waves, and calculates the reflection position and the relative speed at a predetermined cycle, and then transmits the calculated reflection position and relative speed to the detection ECU 10.

The steering angle sensor 22 detects a steering angle of the own vehicle, and then transmits the detected steering angle to the detection ECU 10.

The detection ECU 10 is connected with the radar unit 21 and the steering angle sensor 22. The detection ECU 10 is a computer including a CPU 11, a RAM 12, a ROM 13, an I/O and the like. The detection ECU 10 implements each function by the CPU 11 executing a program installed in the ROM 13. In the present embodiment, the program installed in the ROM 13 is a control program for detecting an object present ahead of the own vehicle based on the information on the object (the calculated position, relative speed, and the like) detected by the radar unit 21 to perform a predetermined driving support process. The detection ECU 10 corresponds to a collision prediction position calculation section.

In the present embodiment, the driving support process corresponds to a notification process that notifies the driver of an object that is likely to collide with the own vehicle, and a braking process that applies brakes to the own vehicle. Therefore, the own vehicle is provided with a notification unit 31 and a braking unit 32 as safety units that are activated in response to a control command from the detection ECU 10.

The notification unit 31 is a speaker or a display which is provided in the interior of the own vehicle. When the detection ECU 10 determines that a time to collision (TTC), which is the time taken before the own vehicle collides with a target, has become shorter than a first predetermined time, and thus the detection ECU 10 determines that the probability of collision between an object and the own vehicle becomes high, the notification unit 31 outputs an alarm sound, alarm message, or the like according to a control command from the detection ECU 10 to notify the driver of a risk of collision.

The braking unit 32 is a unit that applies a brake to the own vehicle. When time-to-collision becomes shorter than a second predetermined time, which is set to be shorter than the first predetermined time, and thus the detection ECU 10 determines that the probability of collision between the object and the own vehicle becomes high, the braking unit 32 is activated in response to the control command from the detection ECU 10. In detail, braking force is increased in response to the braking operation performed by the driver (braking assistance function), or automatic braking is applied when braking operation is not performed by the driver (automatic braking function).

The position of the object in the information detected by the radar unit 21 may be deviated from the actual position of the object due to turning round (turning) of the own vehicle. To correct the above deviation of the position of the object in the information, there is a conventional technique for calculating a turning angle of the own vehicle relative to the current traveling direction of the own vehicle to correct the position of the object in the coordinate system based on the calculated turning angle. However, the position information of the object is used not only for determination of the collision between the own vehicle and the object but also for various processes. Therefore, if the position information of the object is erroneously corrected using the conventional technique, the influence of the erroneous correction may increase.

Therefore, the detection ECU 10 according to the present embodiment predicts a collision between the object and the own vehicle without correcting the position information of the object even if the position of the object in the information is deviated from the actual position of the object due to turning of the own vehicle. The method of predicting a collision between the object and the own vehicle performed by the detection ECU 10 will be described below. For the prediction of a collision between the own vehicle and the object in the case where the own vehicle does not turn (travels straight), an approximate straight line is calculated by applying straight line fitting using the least squares method or the like to the positions of the object relative to the own vehicle that have been calculated multiple times in the past by the radar unit 21, as shown in FIG. 2. Then, the position where the calculated approximate straight line overlaps with the own vehicle is calculated as a collision prediction position (In FIG. 2, the collision prediction position is not calculated because the approximate straight line does not overlap with the own vehicle).

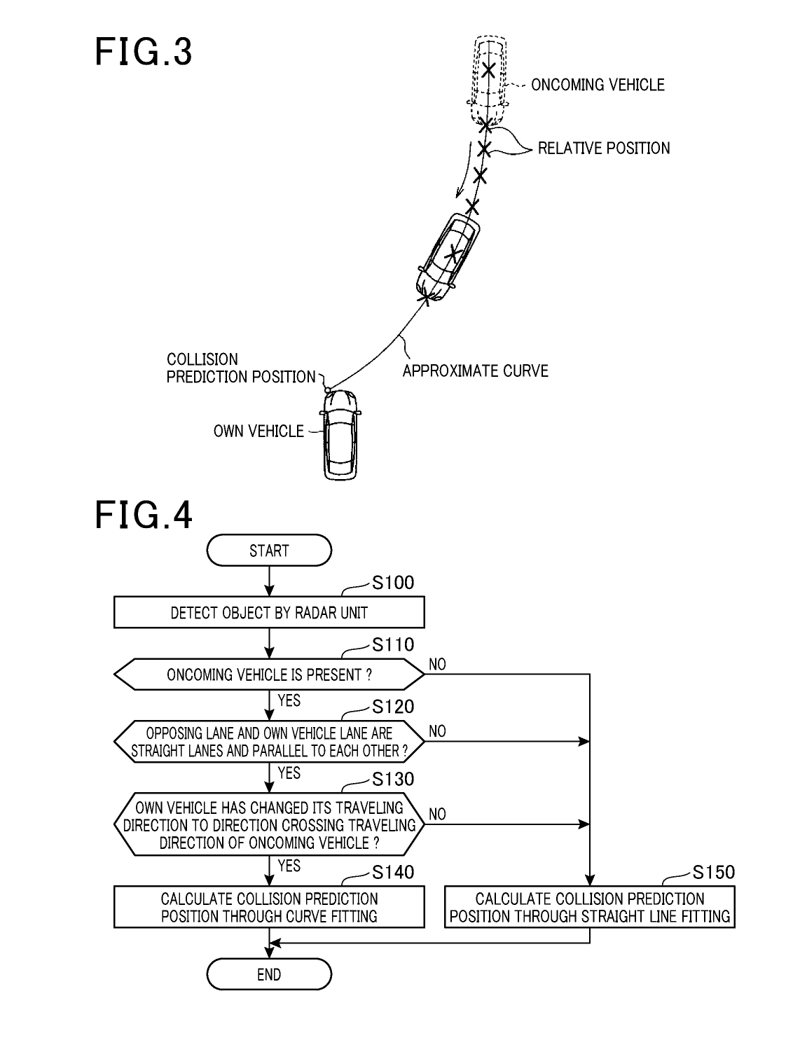

Let us assume a case where the detection ECU 10 has determined that the own vehicle is turning in the direction crossing the traveling direction of the object, based on the position information of the object detected by the radar unit 21 and the information on the steering angle of own vehicle detected by the steering angle sensor 22. In this case, as shown in FIG. 3, the relative positions of the object are plotted on a curve such as that of a quadratic function in a coordinate system. Therefore, when it is determined that the own vehicle is turning in the direction crossing the traveling direction of the object, an approximate curve is calculated by applying curve fitting to the relative positions of the object that have been calculated multiple times in the past by the radar unit 21. Then, the position where the calculated approximate curve overlaps with the own vehicle is calculated as a collision prediction position. Accordingly, the deviation of the collision prediction position due to turning of the own vehicle can be reduced. The position information of the object does not need to be corrected. Therefore, even if the collision prediction position is erroneously calculated, the erroneous calculation affects only a collision prediction process.

In the present embodiment, the present control is performed for oncoming vehicles traveling in the opposing lane ahead of the own vehicle in the traveling direction. This is because the collision prediction position is required to be calculated with high accuracy in a situation such as an intersection in which the own vehicle intersects with an oncoming vehicle. The calculation of the collision prediction position using curve fitting is performed under conditions that a lane in which the own vehicle travels (hereinafter, referred to as an own vehicle lane) and the opposing lane are straight lanes. If the own vehicle lane and the opposing lane are straight lanes, the traveling direction of the own vehicle traveling in the own vehicle lane is parallel to the traveling direction of the oncoming vehicle. Hence, as long as the own vehicle travels in the own vehicle lane, and the oncoming vehicle travels in the opposing lane, the position of the oncoming vehicle in the information is expected to be less likely to be deviated from the actual position of the oncoming vehicle. However, for example, if the opposing lane curves, the oncoming vehicle changes its traveling direction according to the curved opposing lane. Accordingly, the position of the oncoming vehicle in the information may be deviated from the actual position of the oncoming vehicle, which may increase an error in calculation of the collision prediction position.

Therefore, the collision prediction position is calculated using curve fitting under the conditions that the oncoming vehicle is present ahead of the own vehicle in the traveling direction and the opposing lane in which the oncoming vehicle travels and the own vehicle lane are straight lanes.

In the present embodiment, a collision prediction process in FIG. 4 described later is performed by the detection ECU 10. The collision prediction process shown in FIG. 4 is performed by the detection ECU 10 at a predetermined cycle while the power is turned on by the detection ECU 10.

First, in step S100, an object present ahead of the own vehicle is detected by the radar unit 21. Then, in step S110, it is determined whether the object that has been detected by the radar unit 21 is an oncoming vehicle traveling in the opposing lane. Specifically, a ground speed of the object is calculated from the relative speed of the object calculated by the radar unit 21 and the speed of the own vehicle. Then, if the calculated ground speed has a negative value, the object is determined as an oncoming vehicle. The ground speed of the own vehicle in the traveling direction herein is taken to have a positive value. If it is determined that the object is not an oncoming vehicle traveling in the opposing lane (NO in S110), the process proceeds to step S150 described later. If it is determined that the object is the oncoming vehicle traveling in the opposing lane (YES in S110), the process proceeds to step S120.

In step S120, it is determined whether the opposing lane and the own lane are straight lanes and parallel to each other. Specifically, a plurality of positions through which the own vehicle has traveled in the past are connected by a line to create a movement path. Meanwhile, a plurality of positions of the oncoming vehicle that has been detected in the past by the radar unit 21 are connected by a line to create a movement path. Then, it is determined whether the created movement paths of the own vehicle and the oncoming vehicle are straight. If the movement path of the oncoming vehicle relative to the movement path of the own vehicle is within a predetermined angle, the opposing lane in which the oncoming vehicle travels is determined as being parallel to the own vehicle lane in which the own vehicle travels. In the present embodiment, the predetermined angle is set to 10°. If it is determined that the opposing lane or the own vehicle lane is not a straight lane, or the opposing lane is not parallel to the own vehicle lane (NO in S120), the process proceeds to step S150 described later. If it is determined that the opposing lane and the own vehicle lane are straight lanes and are parallel to each other (YES in S120), the process proceeds to step S130.

In step S130, let us assume that, based on the position information of the oncoming vehicle detected by the radar unit 21 and the information on the steering angle detected by the steering angle sensor 22, it is determined whether the own vehicle has changed its traveling direction to the direction crossing the traveling direction of the oncoming vehicle. If it is determined that the own vehicle has not changed its traveling direction to the direction crossing the traveling direction of the oncoming vehicle (NO in S130), the process proceeds to step S150. In step S150, the relative positions of the oncoming vehicle calculated multiple times by the radar unit 21 in the past are approximated by straight line fitting, and based on the calculated approximate straight line, a collision prediction point is calculated. Then, the present control is terminated. If it is determined that the own vehicle has changed its traveling direction to the direction crossing the traveling direction of the oncoming vehicle (YES in S130), the process proceeds to step S140. In the step S140, the relative positions of the oncoming vehicle calculated multiple times in the past by the radar unit 21 are approximated by curve fitting, and based on the calculated approximate curve, a collision prediction point is calculated. Then, the present control is terminated.

With the aforementioned configuration, the present embodiment provides the advantageous effects described below.

When the own vehicle turns in the direction crossing the traveling direction of the oncoming vehicle traveling in the opposing lane, the collision prediction position is corrected. Accordingly, even when the position of the oncoming vehicle in the information is deviated from the actual position of the oncoming vehicle due to turning of the own vehicle, the influence of the above deviation can be reduced by correcting the collision prediction position, resulting in improvement of the accuracy of collision prediction. In addition, by performing a correction for reducing the influence of the above deviation of the position in the information only to the collision prediction position, the influence of the erroneous correction, if any, can be minimized.

By correcting the collision prediction position based on the traveling state of the own vehicle only when the own vehicle lane and the opposing lane are straight lanes, the collision prediction position can be stably corrected.

The influence of the deviation of the position of the oncoming vehicle in the information due to turning of the own vehicle in the direction crossing the traveling direction of the oncoming vehicle can be suppressed by changing the fitting method from straight line fitting to curve fitting. However, when the own vehicle is not turning in the direction crossing the traveling direction of the oncoming vehicle, the collision prediction position can be stably calculated through straight line fitting, further enabling appropriate calculation of the collision prediction position according to the traveling state of the own vehicle.

By performing the present control for an oncoming vehicle traveling in the opposing lane ahead of the own vehicle in the traveling direction, the present control can prevent a collision between the own vehicle and the oncoming vehicle in a situation, such as intersections, where the own vehicle intersects with the oncoming vehicle.

When the own vehicle lane or the opposing lane curves, the collision prediction position is not corrected. Accordingly, the increase in a calculation error of the collision prediction position can be prevented.

The aforementioned embodiment can be modified as described below.

In the aforementioned embodiment, the present control is performed for oncoming vehicles traveling in the opposing lane. In this regard, the present control is not targeting only oncoming vehicles. The present control may target, for example, a pedestrian or a bicycle because the object targeted for the present control may be at least one that is opposed to the own vehicle at the position deviated from the traveling direction of the own vehicle.

In the aforementioned embodiment, the radar unit 21 detects a target. In this regard, the radar unit 21 is not necessarily used but an imaging device 23, for example, may detect a target. The imaging device 23 includes, for example, a CCD camera, a CMOS image sensor, a monocular camera or a stereo camera using a near-infrared camera or the like. In this case as well, the position information and relative speed of the target can be calculated based on the image captured by the imaging unit 23. Accordingly, this configuration provides the same advantageous effects as those of the aforementioned embodiment. The detection of the target performed by the radar unit 21 and the detection of the target performed by the imaging device 23 may be combined with each other.

In the aforementioned embodiment, it is determined whether the opposing lane and the own vehicle lane are straight lanes and are parallel to each other. In this regard, the determination as to whether the opposing lane and the own vehicle lane are straight lanes and parallel to each other does not necessarily have to be performed.

In the aforementioned embodiment, the determination as to whether the own vehicle has changed its traveling direction to the direction crossing the traveling direction of the oncoming vehicle is performed based on the position information of the oncoming vehicle detected by the radar unit 21 and the information of the steering angle detected by the steering angle sensor 22. In this regard, the information on the steering angle detected by the steering angle sensor 22 does not necessarily have to be used. For example, the driving support apparatus 100 may be provided with a yaw rate sensor to detect a yaw rate of the own vehicle. Based on the detected yaw rate, the detection ECU 10 may calculate the steering angle relative to the traveling direction of the own vehicle to determine whether the own vehicle has changed its traveling direction to the direction crossing the traveling direction of the oncoming vehicle based on the detected steering angle.

The present disclosure has been based on embodiments; however, the present disclosure should not be construed as being limited to these embodiments and configurations. The present disclosure should encompass various modifications and alterations within the range of equivalency. In addition, various combinations and modes, as well as other combinations and modes, including those which include one or more additional elements, or those which include fewer elements should be considered to be in the scope and spirit of the present disclosure.

1. A collision prediction apparatus comprising:
an object detection section that detects an object present ahead of an own vehicle; and
a collision prediction position calculation section that calculates a collision prediction position that is a position where the object is predicted to collide with the own vehicle in the future based on a position of the object detected by the object detection section relative to the own vehicle, wherein
the collision prediction position calculation section corrects the collision prediction position when the object detected by the object detection section is traveling in an opposite direction to the own vehicle at a position deviated from a traveling direction of the own vehicle, and the own vehicle turns in a direction crossing a traveling direction of the object.

2. The collision prediction apparatus according to claim 1, wherein the collision prediction position calculation section corrects the collision prediction position under an additional condition that it has been determined that the traveling direction of the object and the traveling direction of the own vehicle are parallel to each other.

3. The collision prediction apparatus according to claim 1, wherein when the collision prediction position is not corrected, the collision prediction position calculation section obtains an approximate straight line by applying straight line fitting to the relative positions that have been calculated in the past to calculate the collision prediction position based on the approximate straight line, and when the collision prediction position is corrected, the collision prediction position calculation section calculates an approximate curve by applying curve fitting to the relative positions that have been calculated in the past to calculate the collision prediction position based on the approximate curve.

4. The collision prediction apparatus according to claim 1, wherein the object detection section detects an oncoming vehicle traveling in an opposing lane ahead of the own vehicle in a traveling direction of the own vehicle.

5. The collision prediction apparatus according to claim 4, wherein the collision prediction position calculation section corrects the collision prediction position under a condition that an own vehicle lane in which the own vehicle travels and the opposing lane are straight lanes.

6. The collision prediction apparatus according to claim 5, wherein the collision prediction position calculation section does not correct the collision prediction position when the own vehicle lane or the opposing lane curves.
